(19) United States
(12) Patent Application Publication
(10) Pub. No.: US 2003/0115133 A1
(43) Pub. Date: Jun. 19, 2003

(54) Higher risk score for identifying potential illegality in business-to-business relationships

(75) Inventor: Jie Bian, Basking Ridge, NJ (US)

Correspondence Address: Paul D. Greeley, Esq., Ohlandt, Greeley, Ruggiero & Perle, L.L.P., 10th Floor, One Landmark Square, Stamford, CT, 06901-2682, US

(73) Assignee: DUN & BRADSTREET, INC., MURRAY HILL, NJ

(21) Appl. No.: 10/021,253

(22) Filed: Dec. 13, 2001

(51) Int. Cl. G06F 17/60

(52) U.S. Cl. 705/38

(57) ABSTRACT

A system for providing a user with a higher risk score indicating the likelihood that a business under inquiry by the user is involved in questionable activity comprising a means for evaluating how closely the profile of the business under inquiry matches those of businesses already confirmed as higher risk wherein a neural network model is capable of capturing the way multiple variables (or factors or characteristics) inter-relate or recognizing patterns indicative of questionable activity;

### FIELD OF THE INVENTION

The present invention pertains to a process and system for enabling a business user to ascertain efficiently the risk involved in dealing with particular businesses; and in particular, enables the user to determine if his customer's business under inquiry looks like or behaves similarly to other businesses which have been involved in questionable, even illegal, activity so that the user of the system will be forewarned of the likelihood of problems ahead and can take necessary precautions.

### BACKGROUND OF THE INVENTION

There has existed for some years a scheme or system for obtaining the aforenoted objective of alerting a customer to the risks involved in dealing with certain businesses. However, the previous methodology involved has been a traditional linear regression methodology, which is not efficient in capturing rare and hard to find cases of risky businesses.

The present invention resides in a system and process that proceeds on the knowledge derived from the existence of neural networks which basically are a form of artificial intelligence which operate like the human brain, being able to learn patterns and relationships involved with data as the network is exposed to the data.

What has been recognized by the present inventor is that a useful model can be developed based on neural network knowledge and directed to the aforenoted purpose, that is, to achieve a result that is determinative of the likelihood that a given business resembles businesses that have shown by certain characteristics to have a proclivity for questionable activity. The neural network model, in contrast with the regression-type methodology, such as logistic regression, can capture the rare and hard to find cases much more effectively. The model identifies and classifies companies as to their likelihood of being confirmed as higher risk by capturing the way multiple variables inter-relate and by recognizing the patterns developed that are highly indicative of questionable behavior.

Accordingly, the higher risk model of the present invention utilizes the combined power of the assignee's (Dun & Bradstreet's) vast information database of over 13 million U.S. businesses and other third party information to assess how closely the subject business resembles confirmed questionable businesses.

It will be appreciated that a primary object of the present invention is to provide a simple and efficient system and process that yields a figure of merit in the form of a higher risk score that will help protect a company from doing business with higher risk businesses prior to extending credit or shipping goods. Therefore, customers of the system can most effectively use the score as an alert system, enabling them to target their investigations to their most risky accounts.

### SUMMARY OF THE INVENTION

In fulfillment of the above-noted objects, the higher risk score that is obtained by the system of the present invention is based on detecting patterns of possible questionable activity in an otherwise seemingly legitimate business. The higher risk score is not a predictor of future illegal activity. This will be understood from the fact as noted that the neural network model assesses the degree to which a business's characteristics, or data elements, look like the characteristics of previously confirmed questionable businesses at the time of scoring. If the correlation is high, the business inquired of will be classified as higher risk; if it is low, it will be classified as lower risk.

The neural network model is trained based on the observed characteristics of companies in Dun & Bradstreet's proprietary database of more than 12,000 confirmed cases of businesses guilty of questionable—even illegal—activity, such as misrepresentation. This proprietary database of more that 12,000 confirmed cases meets Dun & Bradstreet's definition of “higher risk.” A Dun & Bradstreet confirmed “higher risk” company is one that (a) has been indicted or convicted of illegal activities, (b) provides information that conflicts with public or third party sources, (c) omits significant negative information, (d) deliberately misrepresents information to Dun & Bradstreet or their suppliers and customers.

Briefly stated, then, a broad feature of the present invention resides in a system for providing a user with a higher risk score indicating the likelihood that a business under inquiry by the user is involved in questionable activity comprising: means for evaluating how closely the profile of the business under inquiry matches those of businesses already confirmed as higher risk businesses, wherein a neural network model is capable of capturing the way multiple variables, or data elements, inter-relate and of recognizing patterns indicative of questionable business activity.

The higher risk model assigns a score of 0-3 and “E”. A 0 represents businesses that are already confirmed as higher risk or discontinued location or open bankruptcy. A score of 1 represents businesses that possess the least risk of future illegal activity, and a 3 represents businesses that possess the highest risk of future illegal activity. E represents businesses excluded from scoring due to numerous reasons.

The foregoing and still further objects and advantages of the present invention will be more apparent from the following detailed explanation of the preferred embodiments of the invention in connection with the accompanying drawing.

### BRIEF DESCRIPTION OF THE DRAWINGS

FIG. 1 is a block diagram of a system, preferably including a network, for carrying out the basic process, including receiving an inquiry from a customer and enabling him/her to determine the risk involved in dealing with a particular business.

FIG. 2A is a block diagram depicting an overview of the information or data flow in accordance with the basic process of a preferred embodiment of the present invention.

FIG. 2B is a block diagram depicting the arrangement for training the neural network of the system at the pre-process stage to create a model for comparing the characteristics of a business under inquiry with businesses already studied and confirmed to be risky.

FIG. 3 is a block diagram of the computer system within the overall system for directing, by program means, the implementation of the process of FIG. 2A and FIG. 2B.

FIG. 4 is a diagram which depicts a neural network having several layers of nodes.

FIG. 5 is a diagram which depicts in some detail what happens inside a hidden node.

### DETAILED DESCRIPTION OF THE INVENTION

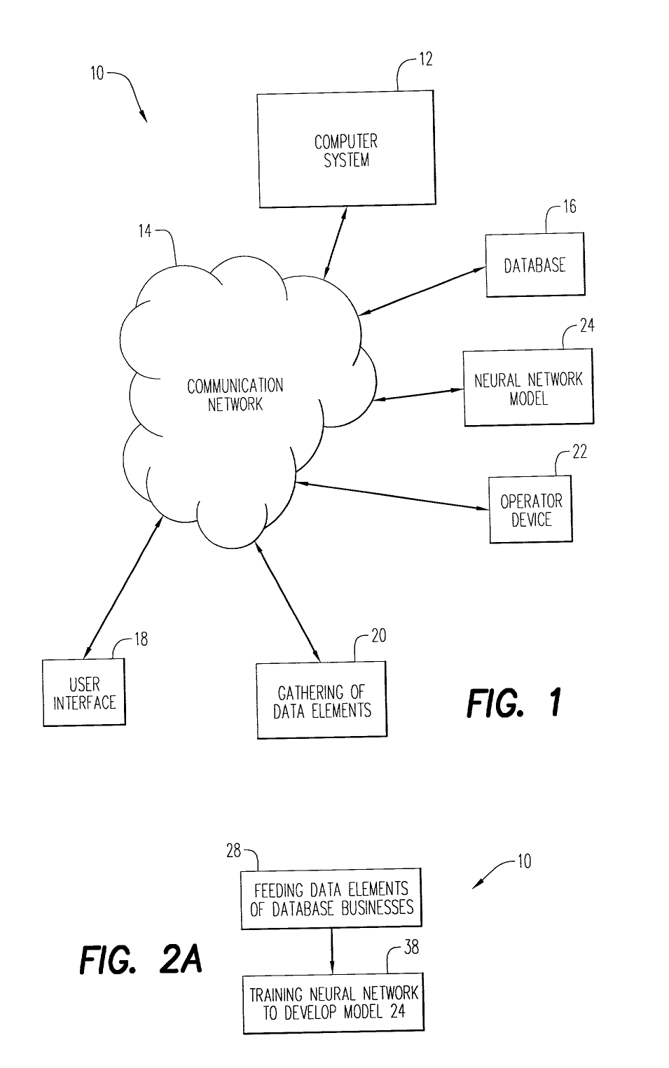

Referring, first of all, to FIG. 1 there will be seen a communication system 10 which includes a computer system 12, a communication network 14, and a user interface 18. The communication network 14 may be any wired or wireless network capable of conducting communications. For example, network 14 may be an Internet, an Intranet, the Worldwide Web (hereinafter referred to as the “WWW” or the “Web”), the public telephone network. Network communication capability such as by modems, browsers and/or server capability (not shown) is associated with the user interface 18 so that suitable access may be gained to the communication system 10.

The user interface 18 may be connected with any suitable customer device from which a browser may run, such as a personal computer, a telephone, a television set and the like. Alternatively, a customer device may communicate with computer system 12 via off-line connections (not shown).

In addition to access through the communication network 14 by use of the user interface 18 there is also provided an operator device 22 so that the Dun & Bradstreet operator may in access by way of the network 14 to the data gathering component 20 and to all the other components, including the computer system 12, in the operations of assembling a higher risk score database 16—forming part of a large data base—which part contains confirmed cases of risky businesses as that term has been used heretofore. Also, enabled for communication purposes is access by the operator for training a neural network, so as to produce the neural network model 24. This is done at the pre-process or initial stage before the system is accessed by a user by way of the interface 18 so that a user may query the system about a particular business.

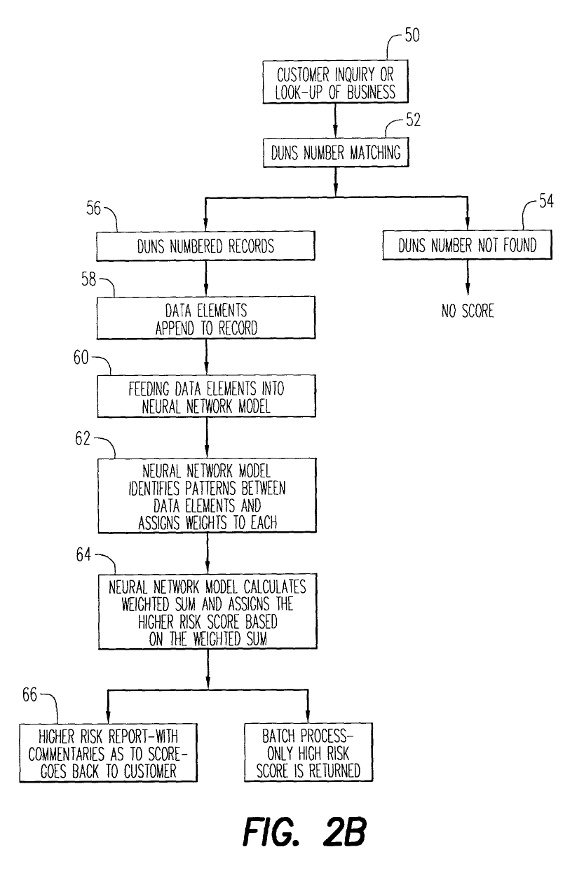

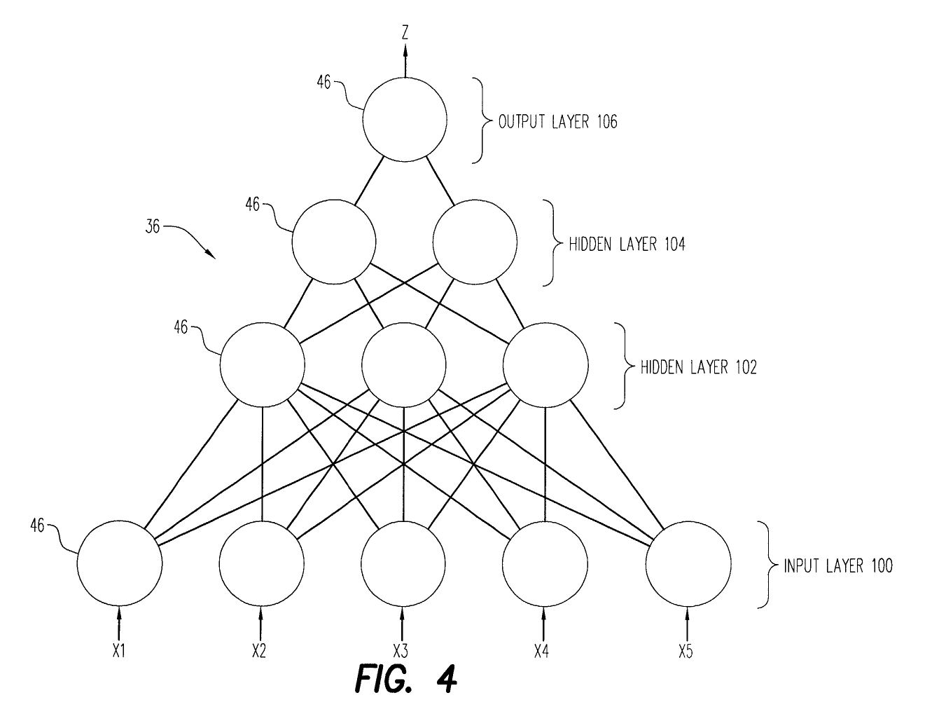

Referring now to FIG. 2A, there are seen the steps, in the initial stage of the process, the first step 28 being the feeding of the data elements, which are the characteristics of the higher risk businesses stored in database 16 to the neural network 36 (FIG. 4) which, by its nature, functions to receive such data elements. A training operation 38 involving inserting in several different layers of the network the exemplary data elements listed in Table 1 is carried out such that an inter-relationship and pattern of the different data elements is established. The list of these data elements in Table 1 is not exhaustive and other data elements can be included.

TABLE 1

| Data | |
|---|---|
| Elements | Impact on Model |
| History | A “Business” or “Management” history adversely |
| Indicator | impacts the score. Business History relates to the firm/ |
| | parent/subsidiary when it is the defendant in criminal |
| | proceedings, files bankruptcy or debt arrangement, or has |
| | significant public filings. Management history relates to |
| | owners/managers of a firm when there are criminal |
| | actions against those persons, individual bankruptcies, or |
| | bankruptcies/unpaid obligations related to companies |
| | affiliated with the same individual. |
| Suits, Liens, | The presence as well as the volume, of open suits, liens, |
| Judgments | or judgments. These are typically unforeseen circum- |
| | stances that may negatively impact a business. The |
| | absence of public filings is considered a positive factor. |
| UCC Filing | The presence of UCC filings has a positive impact on the |
| Indicator | score. |
| SIC | Certain SIC codes are associated with greater occurrences |
| | of higher risk. The presence of these SIC codes will |
| | negatively impact the score. |
| Name | Certain business names have a greater likelihood of being |
| | linked to higher risk cases. The prese3ntce of any of |
| | these busine4ss names will have an adverse effect on the |
| | score. |
| Company Age | Younger companies tend to be riskier than more |
| | established companies. |
| MSA | Certain geographic areas have greater incidences of |
| | higher risk businesses operating within them. A business |
| | location in one of these areas will have a negative impact |
| | on the score. |
| Mail Drop | The presence of a mail drop location as a business |
| | address may be an indicator of higher risk. |
| Ownership of | Firms that own their own facilities are, in general, less |
| Facility | risky than those that rent or lease space. |
| Number of | In general, the greater the number of employees, the less |
| Employees | risk associated with the company. |
| Satisfactory | The higher the number of positive trade experiences that |
| Payment | D&B has reported on an individual firm, the lower the |
| Experience | likelihood of risk. A lack of satisfactory payment |
| | experiences negatively impacts the score. |
| Inquiry Spike | The presence of this indicator means there has been a |
| | spike in the number of inquiries made on the subject |
| | company within the past 90 days. A spike in inquiries |
| | tends to be an indicator of higher risk. |

The net result is that the model thus formed is capable of producing variable risk scores from its learning process based on confirmed businesses that have been shown to be risky.

It is considered useful to describe in structural terms the neural network 36, which is a form of artificial intelligence. With respect to the present invention its specific form is a computer program to be described, which is capable of learning the relationships and the patterns among the data variables, that is the data elements, as herein designated. These variables are interconnected in the network in multiple “layers.”

Referring now to FIG. 4 there is seen a diagram which illustrates the neural network structure. There are four layers 100, 102, 104, 106. In each layer there is a set of nodes 46 loosely analogous to neurons in the brain, hence the name neural networks. These nodes are interconnected as seen in the network so that the network can then identify patterns in the data as it is exposed to the data. In a sense, the network learns from experience just as people do. This distinguishes neural networks, considered herein in their computer program form, from traditional computer programs that simply follow instructions in a fixed sequential order.

The structure of the neural network 36, from which the higher risk model 24 (FIG. 1) is derived, consists of a bottom layer which represents the input layer 100 of the network and which receives the data elements as inputs. As seen for the layer 100, there are five inputs labeled X1 through X5. In the next layer above 100 is layer 102, which is a “hidden layer” with a variable number of nodes—here 3. It is this hidden layer, as well as the hidden layer 104, which has two nodes and is located above layer 102, that performs much of the work of the network. Thus, within these hidden layers, the network learns the interdependencies of the variables; i.e., data elements.

The output layer; i.e., layer 106, has a single node and represents a single output value that one is trying to determine from the inputs X1-X5. It will be understood that in the case of the present invention, one is looking to establish a risk score at the output based on the input data elements (Table 1) of confirmed high risk businesses obtained from the database 16. Each of the nodes in hidden layer 102 is fully connected to every one of the nodes in input layer 100, and each of the two nodes in the second hidden layer 104 is fully connected to the nodes of the first hidden layer. This means that what is learned in the hidden nodes is based on all the inputs taken together, and it is in these hidden layers that the network learns the interdependencies or patterns in the model.

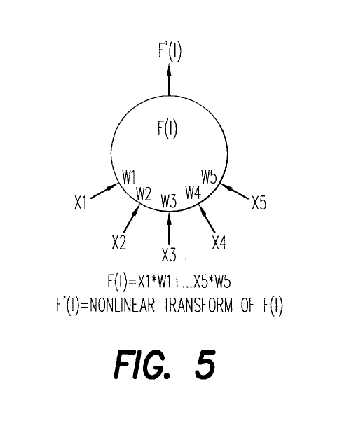

The next diagram; i.e., FIG. 5, provides some detail as to what steps are involved inside a hidden node, for example, each node 46 in the hidden layer 102. The output layer 106 consists of the outcome derived from the model inputs. In the higher risk model the outcome is the higher risk score. There are five potential outcomes from the mode: 1 (Low Risk), 2 (Medium Risk), 3 (High Risk), 0 (Confirmed Higher Risk) and E (Excluded from Scoring).

As already noted, natural networks sift through data, looking for patterns and making associations. The result is an understanding of the factors that impact the outcome it is trying to predict. In D&B's proprietary higher risk neural network model, that outcome is the likelihood a company is involved in questionable activity. The outcome is represented by the higher risk score, which is an assessment of how closely a subject company resembles other companies that have already been confirmed higher risk by D&B.

The backbone of a neural network in accordance with the present invention is the algorithm that detects patterns of data that are characteristic of the outcome one is trying to predict—in this case, companies with questionable intentions. The model goes through the training briefly described previously (see operation 38 in FIG. 2A), which is a key differentiator between neural networks and traditional logistic regression methodology. Training involves exposing large amounts of data that are examples of what you are trying to predict to an algorithm. To train the higher risk model, the very large comprehensive and proprietary database 16 includes over 12,000 confirmed higher risk businesses which are used for purposes of this invention. Through exposure to this database, the model 24 will learn the patterns of characteristics that are highly indicative of these questionable businesses. Once the patterns are learned, the neural network model thus developed uses them to predict the likelihood that a new case will exhibit the same; i.e., highly suspicious behavior. The power of neural networks is that they self-adapt to learn from information, resulting in a tool with knowledge about a specific problem.

Simply stated and based on a computer program implementation of the neural network 36, a weighted sum F(1) is performed as follows: X1 times W1 plus X2 times W2 on through X5 times W5 (see FIG. 5). This weighted sum is performed for each hidden node; i.e., for each node of the hidden layers 102 and 104 and also for the output 21 from the node in output layer 106. It will be understood by those skilled in the art that each of the interactions is thus represented in the network 36. After the weighted sum, each summation is then transformed to F′(1) using a nonlinear function F(1), before the value is passed on to the next layer.

It will therefore be understood that the neural network 36 is repeatedly provided with observations from available data relating to the problem to be solved., including the inputs (X1-X5 in FIG. 5) and also including the desired output Z1, also seen in FIG. 5. The network operates to try to predict the output for each set of inputs by gradually reducing the error. It will be understood there are many algorithms for accomplishing this, but they all involve an iterative search for the proper set of weights. (W1-W5) that will do the best job of accurately predicting the outputs.

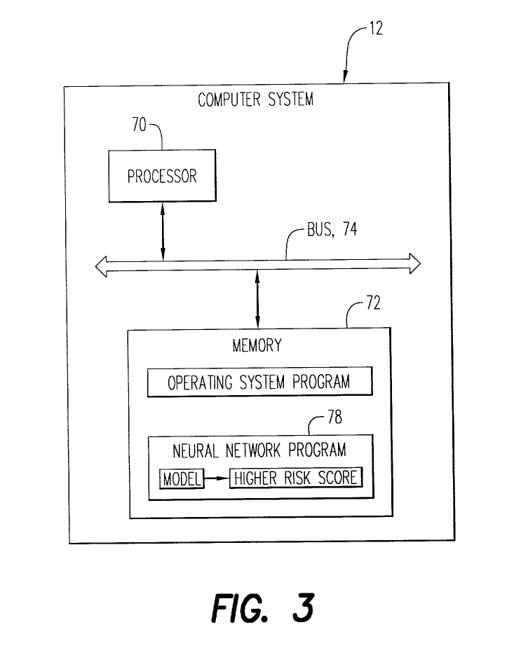

In fulfilling the objective of training the neural network 36 so as to develop the model 24 (FIG. 2A) the user, by way of user interface 18, has access through the network 14 to computer system 1, as seen in FIG. 1. The computer system 12, as shown in some detail in FIG. 3, includes a processor 70 within the computer system for the well-known purpose of executing the program instructions, a memory 72 being shown connected through bus 74 to the processor 70. This memory includes a conventional operating system program 76, but further includes a unique neural network program 78 operable to cause the system to perform the requisite operations of (a) feeding the data elements of the confirmed database businesses from database 16 to the neural network 36 and (b) forming the neural network model 24 (See also FIG. 1), which then becomes available for subsequent operations to be described.

There is illustrated in block form a data flow diagram 2B depicting the main process, that is, the process for determining various risk scores and chiefly for determining the likelihood of a selected business possessing too high a risk for the customer to deal with. Thus, at the first stage of the process seen in FIG. 2B the customer—or in some cases, the operator of the system—downloads through the communication network 14 data from database 16 concerning the business that he wishes to inquire about.

A matching step 52 is performed, and a Dun & Bradstreet's (D-U-N-S®) number is either not found, as shown at 54, or a Dun's numbered record is found at 56. Data elements (Table 1) relating to a particular company that have been gathered by means 20 are appended to the numbered record. Assume, for example, that the record pertains to the XYZ Corporation, then the information covering such company is obtained by the data gathering means 20 and is appended if not already present in the database 16. The information consists of the exemplary data elements noted previously in Table 1. At step 60, these data elements are fed into the neural network model 24. At 62 the neural network model that has been formed previously identifies patterns between data elements for the business under inquiry, and then assigns weights to each. Thereafter, at 64 the neural network model 24 calculates a weighted sum of all the individual elements assigned numbers and compares the weighted sum of the business under inquiry with that of the database confirmed higher risk businesses; i.e., with the average weighted sum of the higher risk businesses already known. Hence a risk score is developed which could, for example, be a 1, 2 or 3. The higher risk score will be assigned to this business depending on how close a match there is between the business under inquiry and the businesses already confirmed as higher risk by Dun & Bradstreet. The higher the weighted sum, the closer the business under inquiry look like the already confirmed higher risk businesses. Thereafter, the risk score generated (step 66) goes back to the customer or user through the network 14 and the interface 18.

It will be understood by reference FIG. 3 that the neural network program operates in two modes previously described, the model mode (with reference to training the neural network) and the compare or Higher Rush Score mode, the first mode being illustrated in FIG. 2A and the Higher Rush Score mode being the part of the program just described for the main process illustrated in FIG. 2B.

It should now have become clear that, as has been pointed out before, a so-called higher risk score, which in accordance with the specific embodiment has a value of 3, serves to detect the patterns of possible extremely questionable activity in an otherwise seemingly legitimate business.

What has also been pointed out in this specific embodiment is that variables or data elements can be utilized or selected within certain desirable limits such as the selection provided in Table 1. However, it will be understood that other company characteristics and activities can be weighted in this system so that they can be used to judge higher risk status if, for example, there is the following: misrepresentation of critical information, such as stock date, business licensing and tax registration; facility description discrepancies; false credit references; business principle/officer who is linked to other confirmed higher risk businesses. The higher risk model, accordingly, assigns a score of 0 to 3. 0 represents businesses that are already confirmed as Higher Risk as reported to Dun & Bradstreet, but Discontinued at this location, or Open Bankruptcy. A score of 1 represents businesses that possess the least risk of future questionable activity, and a 3 represents businesses that possess the highest risk of future illegal activity.

Customers can most effectively use the score as a screening tool that assists in prioritizing accounts for investigation. Customers can protect themselves from potential questionable activity by thoroughly investigating their most risky accounts before shipping goods or extending credit. Rather than investigating all accounts with the same level of detail, the Higher Risk Score enables customers to focus their resources on the accounts most likely to be higher risk D&B's recommended course of action for each higher risk score is as follows:

Higher Risk Score of 3—Conduct an investigation prior to doing business, price for risk or establish up-front payment terms.

Higher Risk Score of 2—Conduct further review and monitor the account.

Higher Risk Score of 1—Proceed with check for credit worthiness with D&B delinquency and failure scores.

The score's benefits are further enhanced when used in conjunction with D&B's other analytical tools, such as D&B's Predictive Scores. When bundled together, they can help protect customers from extending credit to potentially higher score businesses and those that are not credit-worthy.

To help put the score into perspective, the Higher Risk model also provides one with two additional data elements that make the score more meaningful.

1. A Projected Percentage of Businesses Within Score, which tells you what percent of businesses in D&B's scorable population are projected to be assigned the same score. For example, if a business scores a 3, the projected percentage of businesses within that same score will be 0.6%.

2. A Projected Percentage of Confirmed Higher Risk Within Score, which shows you what percent of the businesses that receive the same score are projected to be confirmed higher risk. For example, if a business scores a 3, it is projected that 4.3% of all businesses that receive the same score—which is 0.6% of all businesses scored—will be confirmed higher risk

Additionally, customers who order the score in packet form via D&B or through a third party access system will also receive the Higher Risk Score Percentile. This measurement enables customers to utilize more granular cutoffs to drive their automated decision-making processes. The Higher Risk Score Percentile ranges from 1 (Higher Risk) to 100 (Low Risk).

Tables 1 and 2 illustrate how the Higher Risk Score corresponds with the Percentile Projected Percent of Businesses Within Score, and Projected Percentage of Confirmed Higher Risk Within Score.

TABLE 2
Higher Risk Score Projected Performance Table (Summary)

| | | | | Projected % | Cumulative |
|---|---|---|---|---|---|
| | Higher | | Projected | Confirmed | Incidence |
| Higher | Risk | | % of | Higher | Of Confirmed |
| Risk | Score | | Businesses | Risk | Higher |
| Score | Definition | | Within Score | Within Score | Risk |
| 3 | High | Risk | 0.60% | 4.33% | 22.9% |
| 2 | Medium | Risk | 2.80% | 2.04% | 75.30% |
| 1 | Low | Risk | 96.60% | 0.03% | 100.00% |

The invention having been thus described with particular reference to the preferred forms thereof, it will be obvious that various changes and modifications may be made therein without departing from the spirit and scope of the invention as defined in the appended claims.

What is claimed is:

1. A system for providing a user with a higher risk score indicating the likelihood that a business under inquiry by the user may be involved in questionable activity comprising:
means for evaluating how closely the profile of the business under inquiry matches those of businesses already confirmed as higher risk wherein a neural network model is capable of capturing the way multiple data elements inter-relate and thereby of recognizing patterns indicative of questionable activity, and means for transmitting a report of such risk to the user.

2. A system, as defined in claim 1, further comprising variables selected from the group of data elements:
(a) History Indicator
(b) Suits, Liens, Judgments
(c) UCC Filing Indicator
(d) SIC
(e) Name
(f) Company Age
(g) MSA
(h) Mail Drop
(i) Ownership of Facility
(j) Number of Employees
(k) Satisfactory Payment Experience
(l) Inquiry Spike

3. A system, as defined in claim 1, further comprising a network and, connected to the network, a programmed computer, a user interface, a means for gathering data elements concerning a plurality of businesses, a database having a record of the businesses appended with their respective data elements in the form of variables, or data elements, wherein the neural data elements, assigns weights to the elements to produce a weighted sum wherein higher weighted sums meaning a higher high risk score.

4. A system, as defined in claim 3, providing means for feeding the data elements into the neural network model.

5. A system, as defined in claim 4, including means for identifying the patterns of questionable activity.

6. A system, as defined in claim 5, including means for assigning weights to the data elements to produce a weighted sum.

7. A system, as defined in claim 6, providing means for calculating a weighted sum.

8. A system as defined in claim 1, wherein the evaluated business is given different scores based on how closely its patterns match those of confirmed risk businesses.

9. A method for providing a user with a higher risk score indicating the likelihood that a business under inquiry by the user is involved in questionable activity comprising steps of:
evaluating how closely the profile of the business under inquiry matches those of businesses already confirmed as higher risk wherein a neural network model is capable of capturing the way multiple data elements inter-relate and thereby of recognizing patterns indicative of questionable activity;
transmitting a report of the degree of risk to the user.

10. A method, as defined in claim 9, further comprising variables selected from the group of data elements:
(a) History Indicator
(b) Suits, Liens, Judgments
(c) UCC Filing Indicator
(d) SIC
(e) Name
(f) Company Age
(g) MSA
(h) Mail Drop
(i) Ownership of Facility
(j) Number of Employees
(k) Satisfactory Payment Experience
(l) Inquiry Spike

11. A method, as defined in claim 10, providing steps for feeding the data elements into the neural network model.

12. A method, as defined in claim 11, including steps for identifying the patterns of questionable activity.

13. A method, as defined in claim 12, including steps for assigning weights to the data elements to produce a weighted sum.

14. A method, as defined in claim 13, providing steps for calculating a weighted sum, on which the higher risk score is based.
